(19) United States
(12) Patent Application Publication
(10) Pub. No.: US 2018/0296882 A1
(43) Pub. Date: Oct. 18, 2018

(54) METHOD OF MANUFACTURING A GOLF BALL HAVING A COVER WITH NETWORK STRUCTURE

(71) Applicant: FOREMOST GOLF MANUFACTURE CO.,LTD., TAIPEI CITY (TW)

(72) Inventors: CHIA-SHENG HUANG, TAIPEI CITY (TW); KUAN-WEN CHEN, YUNLIN COUNTY (TW)

(21) Appl. No.: 15/795,408

(22) Filed: Oct. 27, 2017

(30) Foreign Application Priority Data
Apr. 14, 2017 (TW) 106112675

(51) Int. Cl. A63B 45/00; A63B 37/00; C08J 5/04

(52) U.S. Cl. CPC A63B 45/00; A63B 37/0024; A63B 37/0074; A63B 37/0075; C08J 2333/10; A63B 37/0045; C08J 5/04; A63B 37/0064; C08J 2323/08; A63B 37/0076

(57) ABSTRACT

The present invention provides a method of manufacturing a golf ball having a cover with network structure which includes the steps of forming a core layer and forming a cover layer to enclose the core layer. The method characterized in that the cover layer forming step includes the steps of: mixing 90 wt % of a Surlyn resin with 10 wt % of a whisker reinforced material to form a whisker composition; mixing the whisker composition with another Surlyn resin to form a cover layer material, wherein the content of the whisker composition is between 0.1 and 10 phr on the basis of 100 phr of the another Surlyn resin; and injecting the cover layer material to form the cover layer with a whisker-based three-dimensional network structure. The golf ball, after being shot, can achieve both a long flight distance and a greater amount of backspin.

### BACKGROUND OF THE INVENTION

1. Field of the Invention

The instant disclosure relates to a method of manufacturing a golf ball, and more particularly to a method of manufacturing a golf ball having a cover with network structure.

2. Description of Related Art

In recent years, with the continuously rising living standards and the strong emphasis on leisure sports, golf has gradually become one of the popular recreational sports towards people regardless of sex and age. The uniqueness of golf is that players can play a golf match together, even in direct competition with one another (e.g., using handicapped scoring, different tee boxes, in team formats, etc.), and still enjoy the golf outing or competition.

In the golf game, the golfer can hit a golf ball by various means. To win the game, the flight distance upon driver shots and the controllability in the short game are very important. However, the flight trajectory and distance and/or the controllability upon a shot usually depend on the performance of golf ball. For example, some balls having specific hardness and rotation characteristics are designed to fly farther when hit with a faster swinging club, so that a longer flight distance with an accurate direction can be achieved. But for approach shots, a desired flight trajectory and distance need to be achieved by chipping or putting, and thus such hardness and rotation characteristics are not required.

Therefore, the inventor has been actively studying how to improve the flight distance and the controllability of the golf ball according to many years of experience in golf ball designing and manufacturing. Thus, the present invention is developed to overcome the above-mentioned drawbacks associated with conventional golf balls.

### SUMMARY OF THE INVENTION

One aspect of the instant disclosure is to provide a method of manufacturing a golf having a cover with network structure which can meet the requirements for professional golfers and amateur golfers participating in golf tournaments.

According to one of the embodiments of the instant disclosure, the method includes the following steps: forming a core layer; and forming a cover layer to enclose the core layer. The cover layer forming step includes the steps of: mixing 90 wt % of a Surlyn resin with 10 wt % of a whisker reinforced material to form a whisker composition; mixing the whisker composition with another Surlyn resin to form a cover layer material, wherein the content of the whisker composition is between 0.1 and 10 phr on the basis of 100 phr of the another Surlyn resin; and injecting the cover layer material to form the cover layer with a whisker-based three-dimensional network structure.

In one embodiment, in the cover layer forming step, the whisker composition is uniformly dispersed in particle form in the another Surlyn resin, and the content of the whisker composition is between 1 and 5 phr on the basis of 100 phr of the another Surlyn resin.

In one embodiment, in the cover layer forming step, the content of the whisker composition is between 1 and 3 phr on the basis of 100 phr of the another Surlyn resin.

In one embodiment, the whisker reinforced material includes at least one of a metal whisker, an oxide whisker, a carbide whisker, a nitride whisker, a boride whisker, and an inorganic whisker.

In one embodiment, the metal whisker is made of at least one of zinc, nickel, iron, copper, silicon, silver, titanium and cadmium.

In one embodiment, the oxide whisker includes zinc oxide (ZnO) whisker.

In one embodiment, the oxide whisker further includes at least one of magnesium oxide (MgO) whisker, beryllium oxide (BeO) whisker, aluminum oxide (Al₂O₃) whisker, titanium oxide (TiO₂) whisker, yttrium oxide (Y₂O₃) whisker, and chromium oxide (Cr₂O₃) whisker.

In one embodiment, the carbide whisker further includes at least one of silicon carbide (SiC) whisker, titanium carbide (TiC) whisker, zirconium carbide (ZrC) whisker, tungsten carbide (WC) whisker, and boron carbide (B₄C) whisker.

In one embodiment, the boride whisker includes at least one of titanium boride (TiB₂) whisker, zirconium boride (ZrB₂) whisker, tantalum boride (TaB₂) whisker, chromium boride (CrB) whisker, and niobium boride (NbB) whisker.

In one embodiment, the inorganic whisker includes potassium titanium oxide (K₂Ti₆O₁₃), aluminoborate (Al₁₈B₄O₃₃), or the combination thereof.

In one embodiment, the core layer forming step includes forming an inner core layer and then forming an outer core layer to enclose the inner core layer.

In one embodiment, between the core layer forming step and the cover layer forming step, the method further includes a step of forming a mid layer between the core layer and the cover layer.

Based on the above, the method characterized in that it includes the steps of: mixing 90 wt % of a Surlyn resin with 10 wt % of a whisker reinforced material to form a whisker composition, mixing the whisker composition with another Surlyn resin to form a cover layer material, wherein the content of the whisker composition is between 0.1 and 10 phr on the basis of 100 phr of the another Surlyn resin, and injecting the cover layer material to form the cover layer. Accordingly, the whiskers can be uniformly dispersed in the cover layer and thus the surface defect due to aggregation of the whiskers can be prevented.

Furthermore, the golf ball manufactured by the method of which the cover layer is formed with a whisker-based three-dimensional network structure has excellent overall properties. Therefore, the golf ball not only can achieve both a sufficient flight distance and an increased amount of backspin after being shot, but also has high abrasion, high dimensional stability and improved surface strength.

To further understand the techniques, means and effects of the instant disclosure, the following detailed descriptions and appended drawings are hereby referred to, such that, and through which, the purposes, features and aspects of the instant disclosure can be thoroughly and concretely appreciated. However, the appended drawings are provided solely for reference and illustration, without any intention to limit the instant disclosure.

### BRIEF DESCRIPTION OF THE DRAWINGS

The accompanying drawings are included to provide a further understanding of the instant disclosure, and are incorporated in and constitute a part of this specification. The drawings illustrate exemplary embodiments of the instant disclosure and, together with the description, serve to explain the principles of the instant disclosure.

FIG. 1 is a flow chart showing a method of manufacturing a golf ball having a cover with network structure according to the first embodiment of the instant disclosure;

FIG. 2 is a three-dimensional view of the golf ball according to the first embodiment of the instant disclosure;

FIG. 3 is a cross-sectional view of the golf ball according to the first embodiment of the instant disclosure;

FIG. 4 is an enlarged fragmentary perspective view showing a portion of a core layer and a cover layer of the golf ball according to the first embodiment of the instant disclosure;

FIG. 5 is another cross-sectional view of the golf ball according to the first embodiment of the instant disclosure;

FIG. 6 is a flow chart showing a method of manufacturing a golf ball having a cover with network structure according to the second embodiment of the instant disclosure;

FIG. 7 is a cross-sectional view of the golf ball according to the second embodiment of the instant disclosure; and

FIG. 8 is another cross-sectional view of the golf ball according to the second embodiment of the instant disclosure.

### DETAILED DESCRIPTION OF THE PREFERRED EMBODIMENTS

The instant disclosure relates to a modified golf ball and a quick, low-cost, and green method for manufacturing the same. The method characterized in that it includes the steps of mixing a Surlyn resin with a whisker reinforced material in a specific ratio and then injecting a small part of the resulting mixture to form a cover layer. Accordingly, the cover layer can be formed with a whisker-based three-dimensional network structure uniformly dispersed therein, and thus the golf ball can achieve both a sufficient flight distance on driver shots and an increased amount of backspin (especially on chip shots).

Embodiments of a method of manufacturing a golf having a cover with network structure according to the instant disclosure are described herein. Other advantages and objectives of the instant disclosure can be easily understood by one skilled in the art from the disclosure. The instant disclosure can be applied in different embodiments. Various modifications and variations can be made to various details in the description for different applications without departing from the scope of the instant disclosure. The drawings of the instant disclosure are provided only for simple illustrations, but are not drawn to scale and do not reflect the actual relative dimensions. The following embodiments are provided to describe in detail the concept of the instant disclosure, and are not intended to limit the scope thereof in any way.

### First Embodiment

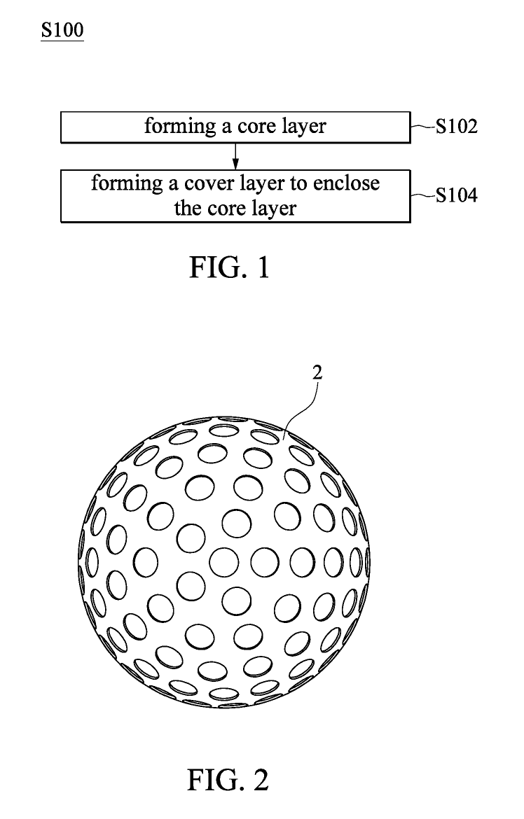

Referring to FIG. 1, there is shown a flow chart showing a method of manufacturing a golf ball having a cover with network structure according to the first embodiment of the instant disclosure. The method S100 is used to manufacture a two-piece golf ball, and includes a step (step S102) of forming a core layer and a step (step S104) of forming a cover layer to enclose the core layer.

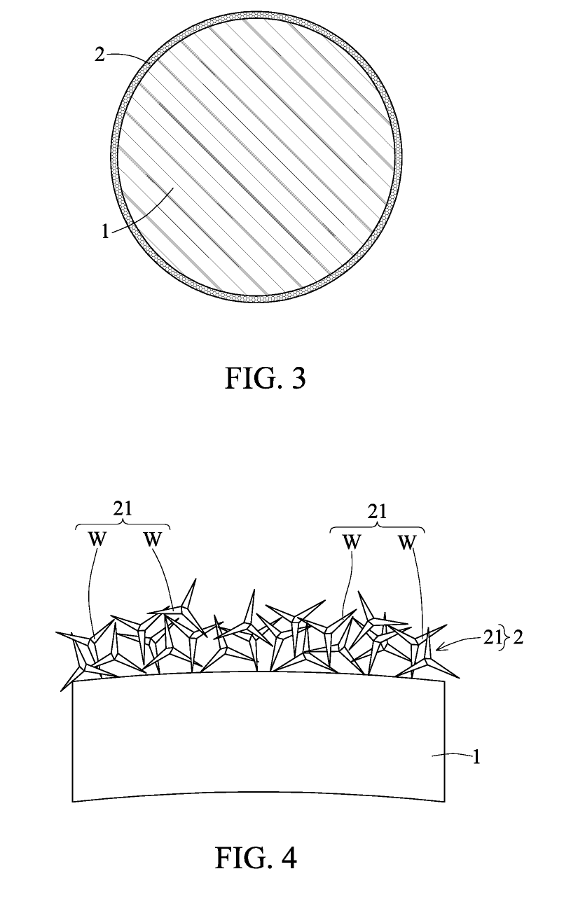

Referring to FIGS. 2 to 4, in the step S102, the core layer 1 can be formed by any well-known method in the art, such as thermoforming or injection molding, and has an outer diameter between 1.40 inches and 1.64 inches. The composition of the core layer 1 includes a butadiene rubber in an amount of 50 wt % to 70 wt % and one or more additives in an amount of 30 wt % to 50 wt %. The additive(s), according to practical needs, can be selected from at least one of barium sulfate (BaSO₄), zinc diacrylate (ZDA), zinc oxide powder, tungsten powder, crosslinking agent, stearic acid, and white carbon, but is not limited thereto.

Furthermore, the method for manufacturing the core layer 1 includes the following steps. Firstly, the butadiene rubber and the additive(s) are mixed and kneaded. Next, the mixed and kneaded material is extruded to form a slug. Finally, the slug is placed in a hot compression mold to form the core layer 1. It should be noted that the butadiene rubber based core layer 1 has high coefficient of restitution (COR), high compression resistance, and high elasticity. Accordingly, the golf ball, after being shot, can achieve a higher ball speed and a reduced amount of backspin so that a long flight distance on driver shots can be obtained.

In the step S104, the cover layer 2 can be formed by injection molding, and has an outer diameter between 1.40 inches and 1.70 inches. The composition of the cover layer 2 includes a Surlyn resin (an ionomer resin sold under the trademark Surlyn of DuPont Company) and a whisker reinforced material W. Specific examples of the Surlyn resin include “Surlyn 8150”, “Surlyn 9150”, “Surlyn 8940”, and “Surlyn 9910”. The whisker reinforced material W includes at least one of a metal whisker, an oxide whisker, a carbide whisker, a nitride whisker, a boride whisker, and an inorganic whisker. The whisker reinforced material W preferably has a diameter between 1 μm and 20 μm and an aspect ratio between 5 and 1000.

In the instant embodiment, the metal whisker can be made of at least one of zinc, nickel, iron, copper, silicon, silver, titanium and cadmium. The oxide whisker includes at least one of zinc oxide (ZnO) whisker, magnesium oxide (MgO) whisker, beryllium oxide (BeO) whisker, aluminum oxide (Al₂O₃) whisker, titanium oxide (TiO₂) whisker, yttrium oxide (Y₂O₃) whisker, and chromium oxide (Cr₂O₃) whisker. The carbide whisker includes at least one of silicon carbide (SiC) whisker, titanium carbide (TiC) whisker, zirconium carbide (ZrC) whisker, tungsten carbide (WC) whisker, and boron carbide (B₄C) whisker. The boride whisker includes at least one of titanium boride (TiB₂) whisker, zirconium boride (ZrB₂) whisker, tantalum boride (TaB₂) whisker, chromium boride (CrB) whisker, and niobium boride (NbB) whisker. The inorganic whisker includes potassium titanium oxide (K₂Ti₆O₁₃), aluminoborate (Al₁₈B₄O₃₃), or the combination thereof.

It should be noted that the whisker reinforced material W dispersed in the cover layer 2 is interweave to form a whisker-based three-dimensional network structure 21 as shown in FIG. 4. The whisker-based three-dimensional network structure 21, most preferably to a whisker-based three-dimensional network structure consisting essentially of zinc oxide whisker, is helpful to increase the flight distance and the backspin amount of the golf ball. In addition, the golf ball manufactured by the method S100 has high dimensional stability and improved surface strength due to the presence of the three-dimensional network structure 21 of the cover layer 2.

Furthermore, the method for manufacturing the cover layer 2 includes the following steps. Firstly, the Surlyn resin and the whisker reinforced material W are mixed and kneaded in a specific ratio to form a whisker composition. Preferably, the Surlyn resin is in an amount of 90 wt % and the whisker reinforced material W is in an amount of 10 wt %. Next, the whisker composition is granulated to form particles by a granulation device. Next, a small part of the whisker composition, in particle form, is blended into another Surlyn resin to form a raw material of the cover layer 2 (i.e., cover layer material). In practice, the content of the whisker composition is between 0.1 and 10 phr on the basis of 100 phr of the another Surlyn resin, preferably between 1 and 5 phr, and more preferably between 1 and 3 phr. Finally, the cover layer material is directly injected to form the cover layer 2.

The surface of the cover layer 2 can be formed with any number of dimples as shown in FIG. 2. The number of dimples can be 250 to 500, and the dimples can have any well-known shape such as, but not limit to, a hemispherical shape as shown in FIG. 2.

Without negatively affecting the desired effect, the surface of the cover layer 2 may be subjected to polishing, nicking, or any other surface treatment to increase binding force or aesthetic appearance. In addition, any surface coating such as a varnish layer, a protective layer, and a label layer may be formed on the surface of the cover layer 2.

### Second Embodiment

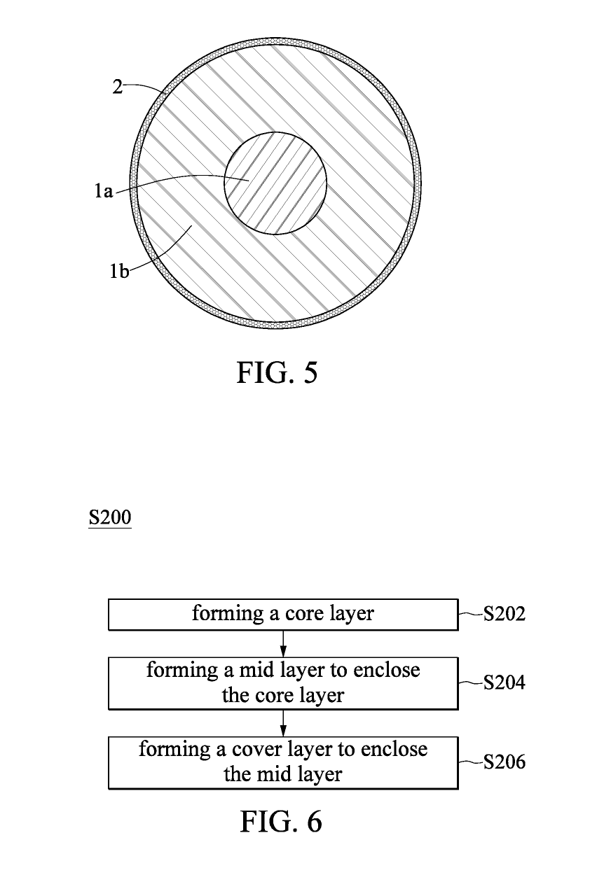

Referring to FIGS. 1 to 5, the technical details of the manufacturing method according to the second embodiment are roughly the same as that of the manufacturing method according to the first embodiment. The main difference between the first and second embodiments is that the step S102 includes forming an inner core layer 1a and then forming an outer core layer 1b to enclose the inner core layer 1a. In the instant embodiment, the outer core layer 1b is formed with a hardness which is greater than that of the inner core layer 1a. Accordingly, by cooperatively using the inner and outer core layers 1a, 1b, the golf ball, after being shot, can achieve a reduced amount of sidespin and maintain a relatively straight flight trajectory to increase its flight distance. The inner and outer core layers 1a, 1b can be made of the same material and method, and a detailed description thereof is omitted herein for the sake of brevity.

### Third Embodiment

Referring to FIG. 6, there is shown a flow chart showing a method of manufacturing a golf ball having a cover with network structure according to the second embodiment of the instant disclosure. The method S200 is used to manufacture a three-piece or multi-layered golf ball, and includes a step (step S202) of forming a core layer, a step (step S204) of forming a mid layer to enclose the core layer, and a step (step S206) of forming a cover layer to enclose the mid layer.

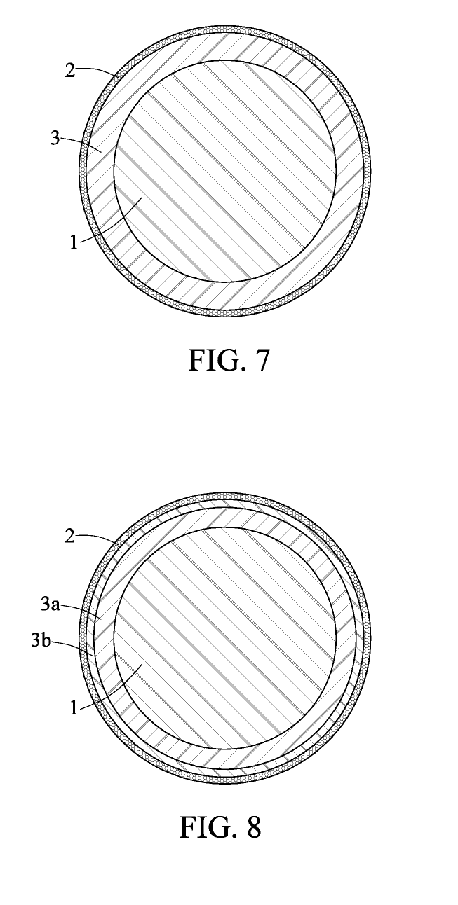

Referring to FIG. 7, the technical details of the manufacturing method according to the second embodiment are roughly the same as that of the manufacturing method according to the first embodiment. The main difference between the first and second embodiments is that a mid layer 3 is provided between the core layer 1 and the cover layer 2. The mid layer 3 can enhance the performance of the golf ball. For example, by cooperatively using the core layer 1 and the mid layer 3, the golf ball, after being shot, can achieve an increased ball speed and an increased flight distance. In addition, by cooperatively using the cover layer 2 and the mid layer 3, the golf ball can achieve an increased amount of backspin on chip shots.

The mid layer 3 can be formed by any well-known method in the art, such as injection molding, compression molding, and casting. The main material of the mid layer 3 can be a HPF resin, a thermoplastic resin, or an ionomer, and the content of which is between 80 wt % and 100 wt %. Specific examples of the HPA resin include HPF1000, HPF2000, HPF AD1035, and HPF AD1040 (all produced by E. I. DuPont de Nemours and Company). The ionomer can be an ethylene/methacrylic acid copolymer with zinc, sodium, lithium, and magnesium ions, etc., and is helpful to increase melting strength (does not break while being stretched under the molten state), impact resistance, tear resistance, durability, elasticity, and chemical resistance. Without negatively affecting the desired effect, one or more well-known additives can be provided to the mid layer 3.

The golf ball manufactured by the method S200 includes the core layer 1 having an outer diameter between 1.30 inches and 1.50 inches, the mid layer 3 having an outer diameter between 1.40 inches and 1.64 inches, and the cover layer 2 having an outer diameter between 1.40 inches and 1.70 inches.

Referring to FIG. 8, the step S204, in another implementation, includes the sub-steps of forming an inner mid layer 3a to enclose the core layer 1 and forming an outer mid layer 3b to enclose the inner mid layer 3a. The outer mid layer 3b has a specific gravity (SG) greater than that of the inner mid layer 3a. The inner and outer mid layers 3a, 3b can have the same composition, and a detailed description thereof is omitted herein for the sake of brevity.

### EXAMPLES 1 AND 2 AND COMPARATIVE EXAMPLE 1

### Example 1

A modified two-piece golf ball in which the cover layer is formed with a whisker-based three-dimensional network structure using 1 wt % of whisker composition.

### Example 2

A modified two-piece golf ball in which the cover layer is formed with a whisker-based three-dimensional network structure using 3 wt % of whisker composition.

### Comparative Example 1

A standard two-piece golf ball in which the cover layer is formed with no whisker-based three-dimensional network structure.

These examples have the same shoreD hardness of 62±2 and compression of 40±5.

The difference in flight distance and backspin amount between the two-piece golf ball according to the first embodiment and the conventional two-piece golf ball is shown in Table 1. In the flight distance and backspin test, balls were hit under the same conditions (e.g., temperature and swing speed and force) with a 6 iron, a driver (TaylorMade JetSpeed fairway wood), and a wedge (standard 56 deg. wedge).

TABLE 1
Evaluation Items

| | Driver | | 6 iron | | Wedge | |
|---|---|---|---|---|---|---|
| Test | Flight | Backspin | Flight | Backspin | Flight | Backspin |
| Samples | distance | amount | distance | amount | distance | amount |
| Com- | 260.4 | 2144.0 | 167.3 | 5441.6 | 73.7 | 6886.1 |
| parative | | | | | | |
| Exam- | | | | | | |
| ple 1 | | | | | | |
| Exam- | 260.5 | 2134.6 | 166.7 | 5585.0 | 72.6 | 8266.4 |
| ple 1 | | | | | | |
| Exam- | 256.1 | 2114.4 | 164.7 | 5776.0 | 72.4 | 8408.1 |
| ple 2 | | | | | | |

As shown in Table 1, the modified two-piece golf balls of Examples 1 and 2, when hit with a driver, respectively have an amount of backspin smaller than that of the standard two-piece golf ball, and the decreased amount of backspin has a positive correlation with the increased content of the whisker composition. Therefore, the modified two-piece golf balls can achieve both an increased amount of backspin and a sufficient flight distance (before the ball lands) upon driver shots. Furthermore, the modified two-piece golf balls of Examples 1 and 2, when hit with a 6 iron or with a wedge, respectively have an amount of backspin larger than that of the standard two-piece golf ball, and the increased amount of backspin has a positive correlation with the increased content of the whisker composition. Therefore, the golfer can hit a ball with a sufficiently large amount of backspin around the greens.

Base on the above, the method of manufacturing a golf ball having a cover with network structure according the embodiments of the instant disclosure characterized in that it includes the steps of: mixing 90 wt % of a Surlyn resin with 10 wt % of a whisker reinforced material to form a whisker composition, mixing the whisker composition with another Surlyn resin to form a cover layer material, wherein the content of the whisker composition is between 0.1 and 10 phr on the basis of 100 phr of the another Surlyn resin, and injecting the cover layer material to form the cover layer. Accordingly, the whiskers can be uniformly dispersed in the cover layer and thus the surface defect due to aggregation of the whiskers can be prevented.

Furthermore, the golf ball manufactured by the method described above of which the cover layer is formed with a whisker-based three-dimensional network structure has excellent overall properties. Therefore, the golf ball not only can achieve both a sufficient flight distance and an increased amount of backspin after being shot, but also has high abrasion, high dimensional stability and improved surface strength.

In addition, by using the method described above, the waste generated in the process and the golf ball after use can be recycled and reused.

The aforementioned descriptions merely represent the preferred embodiments of the instant disclosure, without any intention to limit the scope of the instant disclosure which is fully described only within the following claims. Various equivalent changes, alterations or modifications based on the claims of the instant disclosure are all, consequently, viewed as being embraced by the scope of the instant disclosure.

What is claimed is:

1. A method of manufacturing a golf ball having a cover with network structure, comprising the following steps:
forming a core layer; and
forming a cover layer to enclose the core layer;
wherein the cover layer forming step comprises the steps of:
mixing 90 wt % of a Surlyn resin with 10 wt % of a whisker reinforced material to form a whisker composition;
mixing the whisker composition with another Surlyn resin to form a cover layer material, wherein the content of the whisker composition is between 0.1 and 10 phr on the basis of 100 phr of the another Surlyn resin; and
injecting the cover layer material to form the cover layer with a whisker-based three-dimensional network structure.

2. The method according to claim 1, wherein in the cover layer forming step, the whisker composition is uniformly dispersed in particle form in the another Surlyn resin, and the content of the whisker composition is between 1 and 5 phr on the basis of 100 phr of the another Surlyn resin.

3. The method according to claim 2, wherein in the cover layer forming step, the content of the whisker composition is between 1 and 3 phr on the basis of 100 phr of the another Surlyn resin.

4. The method according to claim 1, wherein the whisker reinforced material includes at least one of a metal whisker, an oxide whisker, a carbide whisker, a nitride whisker, a boride whisker, and an inorganic whisker.

5. The method according to claim 4, wherein the metal whisker is made of at least one of zinc, nickel, iron, copper, silicon, silver, titanium and cadmium.

6. The method according to claim 4, wherein the oxide whisker includes zinc oxide (ZnO) whisker.

7. The method according to claim 6, wherein the oxide whisker further includes at least one of magnesium oxide (MgO) whisker, beryllium oxide (BeO) whisker, aluminum oxide (Al₂O₃) whisker, titanium oxide (TiO₂) whisker, yttrium oxide (Y₂O₃) whisker, and chromium oxide (Cr₂O₃) whisker.

8. The method according to claim 4, wherein the carbide whisker further includes at least one of silicon carbide (SiC) whisker, titanium carbide (TiC) whisker, zirconium carbide (ZrC) whisker, tungsten carbide (WC) whisker, and boron carbide (B₄C) whisker.

9. The method according to claim 4, wherein the boride whisker includes at least one of titanium boride (TiB₂) whisker, zirconium boride (ZrB₂) whisker, tantalum boride (TaB₂) whisker, chromium boride (CrB) whisker, and niobium boride (NbB) whisker.

10. The method according to claim 4, wherein the inorganic whisker includes potassium titanium oxide (K₂Ti₆O₁₃), aluminoborate (Al₁₈B₄O₃₃), or the combination thereof.

11. The method according to claim 1, wherein the core layer forming step comprises forming an inner core layer and then forming an outer core layer to enclose the inner core layer.

12. The method according to claim 1, wherein between the core layer forming step and the cover layer forming step, the method further includes a step of forming a mid layer between the core layer and the cover layer.
